(19) United States
(12) Patent Application Publication
(10) Pub. No.: US 2026/0359292 A1
(43) Pub. Date: Nov. 12, 2026

(54) FLOW ATTRIBUTION COMPUTING SYSTEMS AND RELATED METHODS

(71) Applicant: The Toronto-Dominion Bank, Toronto (CA)

(72) Inventors: Pawel STROJNY, Burlington (CA); Sheldon Lu-Ming TUNG, Markham (CA); Jean-Christophe BOUËTTÉ, Montreal (CA); Boneetha BOSE, Toronto (CA); Syed Muhammad Ghazanfar Ali NAQVI, Mississauga (CA); Omar CHEHAB, Toronto (CA); Beini CHEN, Richmond Hill (CA); Henna Khalid BAIG, Milton (CA)

(21) Appl. No.: 19/202,509

(22) Filed: May 8, 2025

(51) Int. Cl. G06F 16/245

(52) U.S. Cl. CPC G06F 16/245

(57) ABSTRACT

Flow attribution systems and related methods are disclosed. The system includes a memory storing data for a plurality of logs and at least one processor operably coupled to the memory. The data for each log includes flow amounts and balance amounts. The processor is configured to, for each entity of a set of entities, retrieve data from the memory for the logs associated with the entity for a particular time period; for each log, generate aggregated flow data for the particular time period; and define a set of flows associated with the entity by comparing the aggregated flow data for all logs associated with the entity. The processor is further configured to determine an aggregated set of flows associated with the set of entities by aggregating the set of flows associated with each entity; and transmit the set of flows to a computing device for display.

### FIELD

The described embodiments relate generally to computer-implemented systems and methods for attributing flow.

### BACKGROUND

Within a computing environment, there may exist systems that monitor and record flow data. Often, legacy computing systems may record data flow into a destination point or out of a source point. However, such systems may not record the source of the flow or the destination of the flow. Further, such systems may not provide information about the overall flow for a given entity. However, information about the overall flow can allow for improved management of the flow, such as predicting future flow and implementing timely interventions.

### SUMMARY

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

The various embodiments described herein generally relate to systems for attributing flow and related methods.

In accordance with an aspect of this disclosure, there is provided a computing system for attributing flow. The system includes a memory storing data for a plurality of logs and at least one processor operably coupled to the memory. The data for each log includes one or more flow amounts and balance amounts. Each log has a type. The at least one processor is configured to, for each entity of a set of entities, each entity being associated with one or more logs: retrieve data from the memory for the one or more logs associated with the entity for a particular time period; for each log of the one or more logs, generate aggregated flow data for the particular time period; and define a set of flows associated with the entity by comparing the aggregated flow data for all logs of the one or more logs associated with the entity. The aggregated flow data includes a total balance change amount and an aggregated flow amount. Each flow of the set of flows includes an external flow or an internal flow. The external flow includes one or more of an external outflow or an external inflow. The internal flow includes an originating type and a destination type. The at least one processor is further configured to determine an aggregated set of flows associated with the set of entities by aggregating the set of flows associated with each entity of the set of entities; and transmit the set of flows to a computing device for display.

In some embodiments, each log type can have a viscosity level. The at least one processor can be configured to define the set of flows associated with the entity by: identifying pairs of matching logs associated with the entity based on the aggregated flow data; defining an internal flow in the set of flows representative of each pair of matching logs; identifying pairs of matching flows associated with the entity based on the one or more flow amounts associated with each unmatched log; defining an internal flow in the set of flows representative of each pair of matching flows; and defining an external flow for each unmatched flow associated with the entity.

In some embodiments, the at least one processor can be configured to: compare the one or more logs in order of decreasing viscosity level to identify pairs of matching logs based on the aggregated flow data.

In some embodiments, the at least one processor can be configured to: compare the one or more logs in order of decreasing total change amounts to identify pairs of matching flows based on the one or more flow amounts associated with each unmatched log.

In some embodiments, each log type can have a decomposable characteristic or a non-decomposable characteristic; and the at least one processor can be configured to define an external flow for each unmatched log having the non-decomposable characteristic.

In some embodiments, the at least one processor can be further configured to: determine whether the external outflow of the aggregated set of entities is greater than the external inflow of the aggregated set of entities; and in response to determining that the external outflow of the aggregated set of entities is greater than the external inflow of the aggregated set of entities, generate a proposed intervention to increase external inflows and transmit the proposed intervention to the computing device for display.

In some embodiments, the at least one processor can be configured to: determine whether the aggregated flow data for an entity is complete prior to defining the set of flows.

In some embodiments, the at least one processor can be configured to, for the entity: compare the aggregated flow amount with the total change amount; and in response to determining that the total change amount equals the aggregated flow amount, define the set of flows. Otherwise, the at least one processor can transmit an error notification to the computing device for display.

In some embodiments, the set of entities can be defined based on a query received from the computing device.

In some embodiments, the particular time period can be defined based on a query received from the computing device.

In accordance with another aspect of this disclosure, there is provided a computer-implemented method for attributing flow. The method involves operating at least one processor to, for each entity of a set of entities, each entity being associated with one or more logs: retrieve data from a memory for the one or more logs associated with the entity for a particular time period; for each log of the one or more logs, generate aggregated flow data for the particular time period; and define a set of flows associated with the entity by comparing the aggregated flow data for all logs of the one or more logs associated with the entity. The memory stores flow amounts and balance amounts for the one or more logs. Each log can have a type. The aggregated flow data includes a total balance change amount and an aggregated flow amount. Each flow of the set of flows includes an external flow or an internal flow. The external flow includes one or more of an external outflow or an external inflow. The internal flow includes an originating type and a destination type. The method further involves operating the at least one processor to determine an aggregated set of flows associated with the set of entities by aggregating the set of flows associated with each entity of the set of entities; and transmit the set of flows to a computing device for display.

In some embodiments, each log type can have a viscosity level. The method can involve operating the at least one processor to define the set of flows associated with the entity by: identifying pairs of matching logs associated with the entity based on the aggregated flow data; defining an internal flow in the set of flows representative of each pair of matching logs; identifying pairs of matching flows associated with the entity based on the one or more flow amounts associated with each unmatched log; defining an internal flow in the set of flows representative of each pair of matching flows; and defining an external flow for each unmatched flow associated with the entity.

In some embodiments, the method can involve operating the at least one processor to compare the one or more logs in order of decreasing viscosity level to identify pairs of matching logs based on the aggregated flow data.

In some embodiments, the method can involve operating the at least one processor to compare the one or more logs in order of decreasing total change amounts to identify pairs of matching flows based on the one or more flow amounts associated with each unmatched log.

In some embodiments, each log type can have a decomposable characteristic or a non-decomposable characteristic; and the method can involve operating the at least one processor to define an external flow for each unmatched log having the non-decomposable characteristic.

In some embodiments, the method can further involve operating the at least one processor to: determine whether the external outflow of the aggregated set of entities is greater than the external inflow of the aggregated set of entities; and in response to determining that the external outflow of the aggregated set of entities is greater than the external inflow of the aggregated set of entities, generate a proposed intervention to increase external inflows and transmit the proposed intervention to the computing device for display.

In some embodiments, the method can involve operating the at least one processor to determine whether the aggregated flow data for an entity is complete prior to defining the set of flows.

In some embodiments, the method can involve operating the at least one processor to, for the entity: compare the aggregated flow amount with the total change amount; and in response to determining that the total change amount equals the aggregated flow amount, define the set of flows; otherwise, transmit an error notification to the computing device for display.

Other aspects and features will become apparent, to those ordinarily skilled in the art, upon review of the following description of some exemplary embodiments.

### BRIEF DESCRIPTION OF THE DRAWINGS

Several embodiments will now be described in detail with reference to the drawings, in which:

FIG. 1 is a schematic block diagram illustrating an example computing system, according to at least some embodiments;

FIG. 2 is a schematic block diagram illustrating an example computer, according to at least some embodiments;

FIG. 3A is an illustration of an example logs, according to at least some embodiments;

FIG. 3B is an illustration of an example flows corresponding to the logs of FIG. 3A, according to at least some embodiments;

FIG. 4 is a flowchart of an example method of attributing flows, according to at least some embodiments; and

FIG. 5 is a flowchart of another example method of attributing flows, according to at least some embodiments.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

Many legacy computing systems can monitor and record the flow of a resource (e.g., a fluid, aggregate, assets, etc.) to or from a location, or destination. Such legacy computer systems may not record the source or the origination of such flow and the origination of the flow may not be readily identifiable amongst large amounts of data points. Similarly, legacy computer systems may not record the destination of such flow and the destination of the flow may not be readily identifiable amongst large amounts of data points. However, such information can be desirable for better management of the resources.

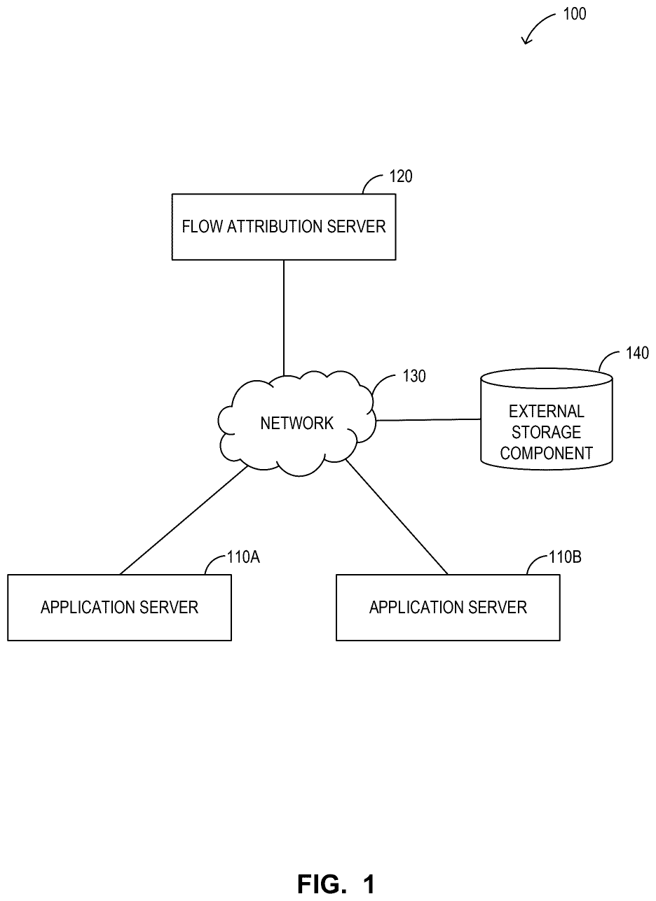

Referring now to FIG. 1, there is illustrated a schematic block diagram of an exemplary computing system 100, in accordance with at least some embodiments. Computing system 100 can include application servers 110a, 110b, (collectively referred to herein as application servers 110), a flow attribution server 120, a network 130, and a database 140.

The application servers 110 and the flow attribution server 120 are computer servers that may be standalone computers, or nodes in a distributed or cloud-based computing system. Accordingly, application servers and the flow attribution server 120 are operatively coupled via network 130, which is a data communications network.

Application servers 110 can be configured to execute various tasks. For example, some application servers 110 can be web servers, other application servers 110 may form nodes in a distributed machine learning system, and so forth. Although two application servers 110 are shown in FIG. 1, the system can include fewer or more application servers.

Network 130 can include any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi®, WiMax®), Signaling System No. 7 (SS7) network, fixed line, local area network, wide area network, and others, including any combination of these, capable of interfacing with, and enabling communication between the flow attribution server 120, the application servers 110 and/or the external storage component 140. Network 130 can include portions of public networks such as the Internet, other public or private networks, cloud systems, and/or other suitable data communication links.

External storage component 140 can include RAM, ROM, one or more hard drives, one or more flash drives or other suitable data storage elements such as disk drives. External storage component 140 can be provided by a database server, or servers, also operatively coupled via network 130. The external storage component 140 can store data in respect of the application servers 110 and/or the flow attribution server 120, including entity data, log data, and/or flow data. Data can be stored in the external storage component 140 for subsequent retrieval by the application servers 110 and/or the flow attribution server 120.

Although the external storage component 140 is described and shown as separate from the flow attribution server 120, other configurations are possible. In some embodiments, the external storage component 140 is hosted by the flow attribution server 120. In some embodiments, the external storage component 140 can be a third-party data storage.

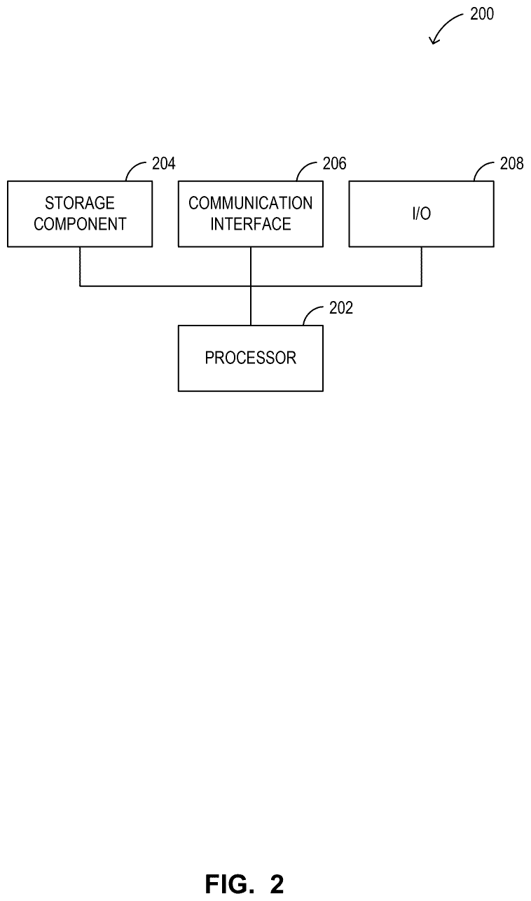

Referring now to FIG. 2, there is illustrated a schematic block diagram of an exemplary computer in accordance with at least some embodiments. Computer 200 is a generic example of a computer, such as the application servers 110 and/or the flow attribution server 120. Computer 200 generally has at least one processor 202 operatively coupled to at least one memory, or storage component 204, at least one communications interface 206, and at least one additional input/output device 208.

The storage component 204, or memory, can include RAM, ROM, one or more hard drives, one or more flash drives or some other suitable data storage elements such as disk drives. For example, the storage component 204 can include volatile and non-volatile memory. Non-volatile memory can store computer programs consisting of computer-executable instructions, which can be loaded into the volatile memory for execution by the processor 202. Operating the processor 202 to carry out a function can involve executing instructions (e.g., a software program) that can be stored in the storage component 204 and/or transmitting or receiving inputs and outputs via the communication component 206. The storage component 204 can also store data input to, or output from, the processor 202, which can result from the course of executing the computer-executable instructions, for example.

The storage component 204 can store data received from a computing device, such as the application servers 110 or the flow attribution server 120. The storage component 204 can also store software applications executable by the processor 202 to facilitate communication between the flow attribution server 120 and the application servers 110, and configuration of the application servers 110 and the flow attribution server 120.

The storage component 204 can include one or more databases for storing data related to entities, logs, and/or flows. The one or more databases can be provided by a database server, or servers. The one or more databases can be any type of database including, but not limited to a relational database, network database, object-oriented database, non-relational database or NoSQL database etc. In some cases, the one or more databases can be implemented in a conventional relational database management system (RDBMS), depending on the specific data being stored.

The processor 202 can control the operation of the computer 200. The processor 202 can include any suitable processors, controllers, digital signal processors, graphics processing units, application specific integrated circuits (ASICs), field programmable gate arrays (FPGAs), microcontrollers, and/or other suitably programmed or programmable logic circuits that can provide sufficient processing power depending on the configuration, purposes and requirements of the computer 200. In some embodiments, the processor 202 can include more than one processor with each processor being configured to perform different dedicated tasks.

The communication component 206 can include any interface that enables the computer 200 to communicate with various devices and other systems. For example, the communication component 206 can facilitate communication with the application servers 110, the flow attribution server 120, and the external storage component 140 via the communication network 130. Although only two application servers 110, one flow attribution server 120, and one external storage component 140 is shown in FIG. 1, the communication component 206 can facilitate communication with any number of application servers 110, flow attribution servers 120, and external storage components 140.

In some embodiments, the communication component 206 can include at least one of a serial port, a parallel port, or a USB port. The communication component 206 may also include a wireless transmitter, receiver, or transceiver for communicating with a wireless communications network, such as the communication network 130. The wireless communications network can include at least one of an Internet, Local Area Network (LAN), Ethernet, Firewire, modem, fiber, or digital subscriber line connection. Various combinations of these elements may be incorporated within the communication component 206.

In some embodiments, the input/output device 208 can include any device that enables the computer 200 to receive input data and/or provide output data. For example, the input/output device 208 can include at least one of various devices, such as a mouse, a keyboard, a touch screen, a thumbwheel, a trackpad, a trackball, a card-reader, voice recognition software, a display screen, a printer, a wireless radio, and the like depending on the requirements and implementation of the computer 200.

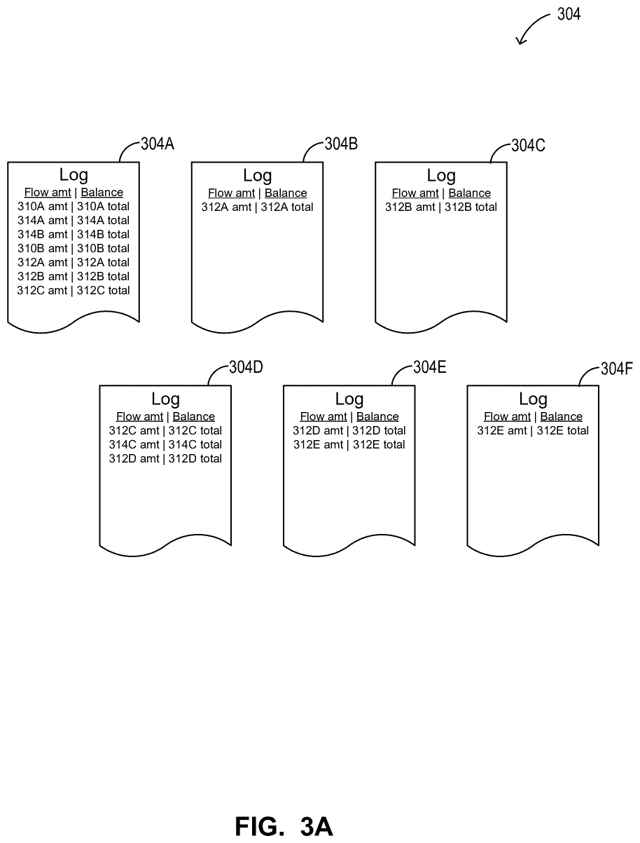

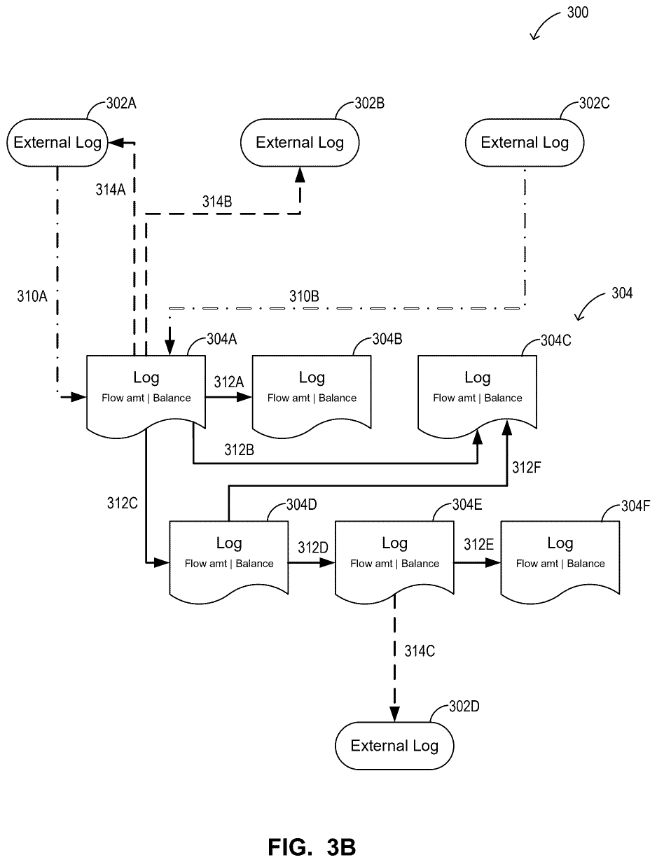

Referring now to FIG. 3A, there is illustrated a diagram of example logs for an entity associated with an institution, in accordance with at least some embodiments.

The entity can be an individual or an organization. As shown, the entity has a plurality of logs 304A, 304B, 304C, 304D, 304E, 304F (herein collectively referred to as logs 304) with the institution. The institution can maintain the logs 304. Although six logs 304 are shown in FIG. 1, fewer or more logs can be associated with an entity.

The logs 304 can correspond to locations for various resources (e.g., items or assets, including but not limited to money, data, goods, transportation capacity, or utilities, such as electricity or water, or other fluids or aggregates, such as gas, oil, cement, etc.). Flow refers to the transfer of resources between the various locations. Computer systems, such as application servers 110A, 110B can monitor and record the flow in corresponding logs. Each log 304 can include log data related to a receipt of flow to that location as a destination and data related to a transmission of flow from that location, as a source or an origination. For example, FIG. 3A shows that log 304A can include seven flows. Meanwhile, logs 304B, 304C, and 304F can include one flow each, and log 304D can include three flows and log 304E can include two flows. The log data for each flow can include a flow amount or size that relates to the amount of resources transferred.

Often, computing systems monitoring and recording the flows can reconcile the individual incoming and outgoing flows associated with a log 304 to determine a balance for that log 304. The balance of a log 304 can represent a cumulative amount of flow for that log 304. When flow transfers to a log 304, the balance of the log 304 can be updated to reflect the inflow, that is, the incoming flow amount. When flow transfers from a log 304, the balance of the log 304 can be updated to reflect the outflow, that is, the outgoing flow amount. Log data for each flow can include the flow amount and a balance, or a daily total. Although not shown in FIG. 3A, log data can also include a date on which each flow occurred.

Each log 304 can have a log type. In some embodiments, two or more logs 304 associated with an entity can be of similar type or different types. Further, each type of log can have certain properties. In some embodiments, the properties of the type can include but is not limited to liquidity, resistivity, impedance, or viscosity. For example, a first log type can be more viscous than a second log type, and a third log type can be more viscous than the second log type. In some embodiments, two log types can have a similar viscosity level.

Computing systems that are monitoring and recording the flows are often legacy computing systems that can not be readily replaced. However, it can be desirable to have more insight about the flows, such as the origination of flow received at a log 304 or the destination of flow transferred from a log 304. Systems and methods disclosed herein can attribute the origination of inflows and destination of outflows recorded in the logs 304 by legacy computing systems. Such information can be used to determine overall, or aggregate flows for a set of logs and provide actionable insight to allow for better management of the flow with various interventions.

Referring now to FIG. 3B, there is illustrated a diagram 300 of example flows corresponding to the logs 304 of FIG. 3A, in accordance with at least some embodiments.

Example flows are shown in diagram 300 by arrows connecting two logs 304, a source log and a destination log. Each flow can be an outflow from a source log and an inflow to a destination log. Further each flow can be an internal flow (indicated by solid lines), or an external flow. Internal flows can be flows between logs 304 maintained by a subject institution. External flows can involve logs maintained by other institutions that are not the subject institution (i.e., an external institution). That is, either the source log or the destination log of an external flow can be maintained by an external institution. In diagram 300, logs 302A, 302B, 302C, and 302D are external logs (herein collectively referred to as external logs 302). Since external logs 302 are maintained by an external institution, the balances and other individual flow amounts may not be known. As such, external logs 302 can be considered non-decomposable.

As shown in diagram 300, the seven flows of log 304A can include: external inflows 310A and 310B (indicated by dash-dot lines) from external logs 302A, 302C, respectively; internal outflows 312A, 312B, and 312C from log 304A to log 304B, 304C, and 304D, respectively; and external outflows 314A, 314B (indicated by dash lines) from log 304A to external logs 302A, 302B, respectively. In addition, internal flow 312D and 312F from log 304D can transfer to log 304E and log 304C, respectively. Further, internal flow 312E from log 304E can transfer to log 304F. As well, external flow 314C from log 304E can transfer to external log 302D.

The flows shown in diagram 300 can occur over time. That is, the flows shown can relate to a given time period. In some embodiments, the time period (i.e., cadence level) can be daily, weekly, monthly, annually, or the like.

In some embodiments, each flow can have a type. The flow type can relate to a method of transfer of the flow from a source log to a destination log. The method of transfer can affect the rate or speed at which the flow occurs.

In some embodiments, the flows can relate to data. In the case of data, the logs can relate to destinations, such as IP addresses, or electronic devices, and the like, and the flow amounts can relate to data size. In some embodiments, the flows can relate to goods. In the case of goods, the logs can relate to physical locations, such as addresses, and the flow amounts can relate to quantity, weight, or cost of the goods.

In some embodiments, the flows can relate to transportation. In the case of transportation, the logs can relate to physical locations, such as addresses, and the flow amounts can relate to a quantity of vehicles, or a weight or volume capacity of the vehicles or robots being transferred. Further, the flow types can relate to a type of transportation, such as but not limited to air, rail, trucking, and the like.

In some embodiments, the flows can relate to electricity. In the case of electricity, the logs can relate to physical locations, and the flow amounts can relate to power. Further, the flow types can relate to the voltage or type of transmission or distribution lines. In some embodiments, the flows can relate to water. In the case of water, the logs can relate to physical locations, such as addresses, and the flow amounts can relate to liquid volume.

In some embodiments, the flows relate to money. In the case of money, logs can relate to financial products and the flow amounts can relate to monetary amounts. Financial products can include but is not limited chequing accounts, savings accounts, credit cards, guaranteed income certificates (GICs), mutual funds, multi-holding accounts, mortgages, lines of credit, and the like. Each financial product can have a liquidity level. For example, a chequing account can be more liquid than a mutual fund, and a mutual fund can be more liquid than a GIC. Further, some product types are not transactional. For example, GICs are not transactional while chequing accounts are transactional. Flow types between financial products can include cheques, electronic money transfers, payments, purchases, and the like.

Continuing with the monetary flow example, the logs 304 shown in diagram 300 can be products associated with a client at a financial institution. In contrast, external logs 302 can be associated with other financial institutions. External logs 302 may or may not be associated with the client at the different institutions. External flow 310A can be a direct deposit to log 304A, which can be a chequing account. External flow 314A can be a cash withdrawal from the chequing account 304A. External flow 314B can be debit purchases from the chequing account 304A. External flow 310B can be an electronic money transfer deposited to the chequing account 304A. Internal flow 312A can be a payment from chequing account 304A to credit card 304B. Internal flow 312B can be a payment from chequing account 304A to mortgage 304C. Internal flow 312C can be a transfer from chequing account 304A to savings account 304D. Further, internal flow 312D can be a transfer from savings account 304D to multi-holding account 304E ; internal flow 312E can be a transfer from multi-holding account 304E to guaranteed income certificate 304F ; and internal flow 312F can be a transfer from savings account 304D to mortgage 304C. Finally, external flow 314C can be an electronic money transfer from multi-holding account 304E.

Although some example flows are shown in diagram 300, it will be appreciated that the challenge of correlating recorded flows to other recorded flows is compounded for an increased number of logs associated with an entity, increased number of entities, and larger query time period, which typically includes an increased number of transactions.

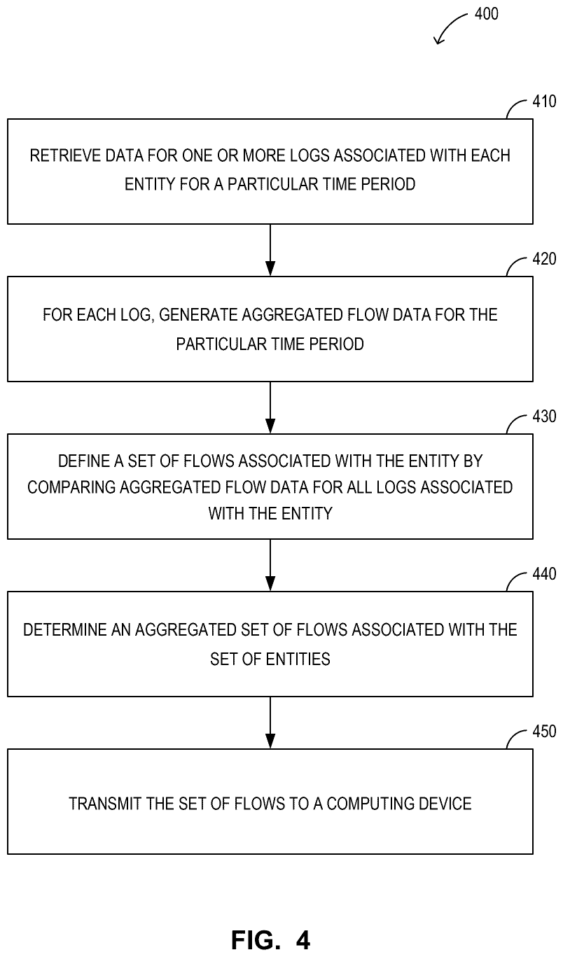

Referring now to FIG. 4, there is illustrated a flowchart diagram of an example method 400 of attributing flows, in accordance with at least some embodiments. To assist with the description of method 400, reference will be made simultaneously to FIG. 1 to 3B. Method 400 can be carried out by a computer, such as flow attribution server 120 of FIG. 1.

Optionally, method 400 can begin when the flow attribution server 120 receives a query. The query can be received from a computing device, such as application server 110A or 110B. The query can define at least one entity and a query time period. In some embodiments, the query can define a set or cohort of entities. For example, the set of entities can include entities that share a common characteristic, such as a geographic area, a related station, a log type, etc.

At 410, the flow attribution server 120 can retrieve log data for the set of entities. The log data can be stored in memory, such as external storage component 140. The flow attribution server 120 can retrieve the log data from the external storage component 140. Each entity can have one or more logs 304. The flow attribution server 120 can identify each log 304 of each entity within the set of entities and retrieve the respective log data for each log 304.

The log data can include each flow into or out of that log 304 within the query time period. The log data can include the flow amount for each flow, and the resulting balance, or daily total, of the log after each flow. Example log data for a plurality of logs 304 is shown in FIG. 3A. The flow attribution server 120 can also determine the log type of each log 304 and the viscosity level of the respective log type.

At 420, the flow attribution server 120 can generate aggregated flow data for the logs 304. That is, the flow attribution server 120 can calculate an aggregated flow amount for the query time period that is a summation of all flows within the query time period. The summation of all flows can be a summation of all inflows amounts less a summation of all outflow amounts.

The flow attribution server 120 can also calculate a total change amount for the query time period. The total change amount can be the difference in the balance, or the daily total at the end of the query time period and the balance, or the daily total at the start of the query time period.

Optionally, the flow attribution server 120 can determine whether the log data for the query time period is complete. In particular, the flow attribution server 120 can compare the aggregated flow amount with the total change amount. If the aggregated flow amount matches the total change amount, the flow attribution server 120 can consider the log data as being complete and proceed with identifying the net flow. If the aggregated flow amount does not match the total change amount, the flow attribution server 120 can consider the log data as being incomplete and the flow attribution server 120 may not proceed with identifying the net flow. Instead, the flow attribution server 120 can generate a notification. The notification can be transmitted to the computing device from which the query was received, such as application servers 110A or 110B.

To identify flows, the flow attribution server 120 can match each entities' log totals and flows. Initially, the flow attribution server 120 can compare the total change amounts of the entities' logs within the subject institution to identify flow within the subject institution between logs 304 for the same entity. The comparison can be performed by using Equation (1):

max(0, min(val1, val2) Equation (1)
wherein val1 is the total change amount of a first log; and
   val2 is the total change amount of a second log.

The flow attribution server 120 can define an internal flow 312 for each pair of matched logs. The internal flow 312 can include an originating type and a destination type and the corresponding amount.

However, entities with multiple flows or logs can be sensitive to the order of matching. As such, the flow attribution server 120 can compare the total change amounts by logs 304 in the order of decreasing viscosity level to capture less frequent flows before more frequent flows.

Some unmatched logs can relate to log types that are not decomposable. Accordingly, the flow attribution server 120 can define external flows 310, 314 for the total change amounts of unmatched logs relating to non-decomposable log types. The comparison can be performed by using Equation (1). For example, an external inflow 310 can be defined for a total change amount that represents flows from an external institution into the subject institution. That is, the originating type is an external institution. The flow attribution server 120 can define an external outflow 314 for a total change amount that represents flow from the subject institution to an outside institution. That is, the destination type is an outside institution.

For the remaining unmatched logs that relate to decomposable types, the flow attribution server 120 can compare the total change amounts with flow amounts. The comparison can be performed by using Equation (1). The flow attribution server 120 can compare the logs 304 in the order of decreasing magnitude of flow amounts to capture large amounts of flow before small amounts of flow. The flow attribution server 120 can define an internal flow 312 for each matched flow.

The flow attribution server 120 can also compare unmatched flow amounts with other unmatched flow amounts. Again, the flow attribution server 120 can compare the flow amounts in the order of decreasing magnitude to capture large amounts of flow before small amounts of flow. The flow attribution server 120 can define an internal flow 312 for each matched flow.

The flow attribution server 120 can determine an aggregated flow for the set of entities. That is, the flow attribution server 120 can determine whether the aggregated flow is external attrition or external aggregation. External attrition can occur when the aggregated external outflow for the set of entities is greater than the aggregated external inflow. External aggregation occur when the aggregated external inflow for the set of entities is greater than the aggregated external outflow. The flow attribution server 120 can transmit the aggregated flow to the computing device from which the query was received, such as application servers 110A or 110B.

In some embodiments, the query can be regularly performed to obtain a series of snapshots over time (e.g., weekly or monthly). Insight from the series of snapshots can allow for interventions to be proposed more proactively (i.e., earlier upon detection of a developing trend). For example, the flow attribution server 120 can determine proposed interventions based on the aggregated flow and transmit the proposed interventions to the computing device, such as, application servers 110A or 110B. Interventions can include, but is not limited to, operational, maintenance, marketing and pricing changes.

Some interventions can be aimed at balancing outflows with inflows. For example, in response to determining that the external outflow 314 is greater than the external inflow 310, the flow attribution server 120 can generate a proposed intervention to increase external inflows 314, thereby balancing the external inflows and the external outflows.

Some interventions can be aimed at adjusting flows of select entities. For example, in response to determining that the external outflow 314 is greater for the select entities than other entities, the flow attribution server 120 can generate a proposed intervention targeted to the select entities to reduce external outflows 314.

Some interventions can be aimed at adjusting flows within a select time period. For example, in response to determining that the external outflow 314 is greater during the select time period, the flow attribution server 120 can generate a proposed intervention to reduce external outflows 314 to be deployed prior to the next occurrence of the select time period.

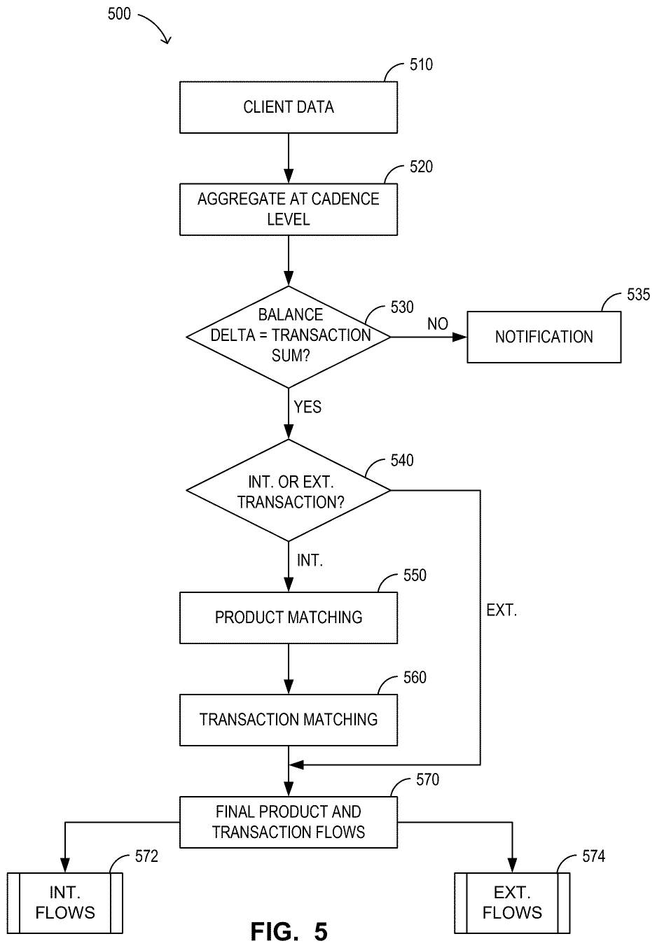

Referring now to FIG. 5, there is illustrated a flowchart diagram 500 of another example method of attributing flows, in accordance with at least some embodiments. To assist with the description of method 500, reference will be made simultaneously to FIG. 1 to 3B. Method 500 can be carried out by a computer, such as flow attribution server 120 of FIG. 1. Although the following description of method 500 will refer to financial products, the method 500 can relate to other resources.

At 510, the flow attribution server 120 can retrieve log data for a particular client. The flow attribution server 120 can identify each log 304 associated with the client and retrieve the respective log data for each log 304. For example, logs 304 can represent a chequing account, a credit card, a mortgage, a saving account, a multi-holdings account, and a GIC that the client has with a subject financial institution. The flow attribution server 120 can retrieve the log data for a given cadence level, or query time period.

At 520, the flow attribution server 120 can calculate an aggregated flow amount for the query time period and a total change amount for the query time period.

At 530, the flow attribution server 120 can determine whether the log data for the query time period is complete. In particular, the flow attribution server 120 can compare the aggregated flow amount with the total change amount. If the aggregated flow amount does not match the total change amount, the flow attribution server 120 can consider the log data as being incomplete and the flow attribution server 120 can generate a notification at 535. If the aggregated flow amount matches the total change amount, the flow attribution server 120 can consider the log data as being complete and proceed to 540.

At 540, the flow attribution server 120 can initially separate log data related to internal and external transactions. Internal transaction data is used at 550 and 560.

At 550, the flow attribution server 120 can compare the total change amounts of the client's logs 304 within the subject institution, that is internal logs 304, to identify flow amongst the client's logs 304. For example, the total change in a client's multi-holding account, such as log 304E, can match the total change in a client's GIC, such as log 304F account. The flow attribution server 120 can define an internal flow 312 for each pair of matched logs. For example, the flow attribution server 120 can define internal flow 312E between matched logs 304E and 304F.

In some embodiments, the flow attribution server 120 can seek to match less frequent flows before more frequent flows. In particular, the flow attribution server 120 can compare the logs 304 in the order of decreasing viscosity level or increasing liquidity. For example, the flow attribution server 120 can first compare the total change amounts of the logs 304 having lowest liquidity.

At 560, the flow attribution server 120 can compare the total change amounts with flow amounts for the remaining unmatched logs that relate to transactional financial products. The flow attribution server 120 can also compare the flow amounts to other flow amounts for the remaining unmatched logs that relate to transactional financial products. For example, the total change amount of the client's savings account, such as log 304D, can match the sum of multiple flow amounts in log 304A, log 304C, and log 304E. The flow attribution server 120 can define an internal flow 312 for each matched flow. For example, the flow attribution server 120 can define internal flows 312C, 312F, and 312D for flow amounts in log 304A, log 304C, and log 304E, respectively that match the total change amount of log 304D.

In some embodiments, the flow attribution server 120 can seek to match larger flows before smaller flows. In particular, the flow attribution server 120 can compare the flows in the order of decreasing magnitude.

The flow attribution server 120 can define an external flow 310, 314 for unmatched flows or unmatched logs, which can relate to financial products that are not transactional. External flows 310, 314 can be defined for the total change amounts of unmatched logs relating to non-transactional financial products. For example, an external inflow 310 can be defined for a total change amount that represents flows from an external institution into the subject institution. An external inflow 314 can be defined for a total change amount that represents flow from the subject institution to an outside institution.

Finally, at 570, the flow attribution server 120 can define final product and transaction flows. The final product and transaction flows can include a set of internal flows 312 and a set of external flows, including external inflows 310 and external outflows 314. The flow attribution server 120 can determine an aggregated internal flow from the set of internal flows 312. The flow attribution server 120 can determine an aggregated external flow from the set of external flows 310, 314.

The flow attribution server 120 can determine an aggregated flow for the client's logs 304. That is, the flow attribution server 120 can determine whether the aggregated flow for the client is external attrition or external aggregation. The flow attribution server 120 can transmit the aggregated flow to the computing device from which the query was received, such as application servers 110A or 110B.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive or. That is, “X and/or Y” is intended to mean X or Y or both, for example. As a further example, “X, Y, and/or Z” is intended to mean X or Y or Z or any combination thereof.

It should be noted that the term “coupled” used herein indicates that two elements can be directly coupled to one another or coupled to one another through one or more intermediate elements.

Unless the context requires otherwise, throughout the specification and claims which follow, the word “comprise” and variations thereof, such as, “comprises” and “comprising” are to be construed in an open, inclusive sense, that is, as “including, but not limited to.”

The embodiments of the systems and methods described herein may be implemented in hardware or software, or a combination of both. These embodiments may be implemented in computer programs executing on one or more programmable devices, each programmable device including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein. These devices may also have at least one input device (e.g. a pushbutton keyboard, mouse, touchscreen, or the like), and at least one output device (e.g. a display screen, a printer, a wireless radio, or the like) depending on the nature of the device.

Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system may be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by Apache Spark™ distributed, cluster-computing framework or a Databricks™ analytical platform. Further, and in addition to the CPUs described herein, the distributed computing components may also include one or more graphics processing units (GPUs) capable of processing thousands of operations (vector operations) in a single clock cycle, and additionally, or alternatively, one or more tensor processing units (TPUs) capable of processing hundreds of thousands of operations (e.g., matrix operations) in a single clock cycle.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high-level procedural or object oriented programming and/or scripting language, or both, to communicate with a computer system. Accordingly, the program code may be written in Python, Java, C++ or any other suitable programming language and may include modules or classes, as is known to those skilled in object-oriented programming. Alternatively, or in addition thereto, some of these elements implemented via software may be written in assembly language, machine language or firmware as needed. In any case, the language may be a compiled or interpreted language. Each such computer program may be stored on a storage media or a device (e.g., ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a non-transitory computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

1. A computing system for attributing flow comprising:
a memory storing data for a plurality of logs, the data for each log comprising one or more flow amounts and balance amounts, each log having a type, each log type having a viscosity level; and
at least one processor operably coupled to the memory, the at least one processor being configured to:
for each entity of a set of entities, each entity being associated with one or more logs:
retrieve data from the memory for the one or more logs associated with the entity for a particular time period;
for each log of the one or more logs, generate aggregated flow data for the particular time period, the aggregated flow data comprising a total balance change amount and an aggregated flow amount; and
define a set of flows associated with the entity by comparing the aggregated flow data for all logs of the one or more logs associated with the entity, each flow of the set of flows comprising an external flow or an internal flow, the external flow comprising one or more of an external outflow or an external inflow, the internal flow comprising an originating type and a destination type;
determine an aggregated set of flows associated with the set of entities by aggregating the set of flows associated with each entity of the set of entities; and
transmit the set of flows to a computing device for display;
wherein the at least one processor is configured to define the set of flows associated with the entity by comparing the one or more logs associated with the entity in order of viscosity level to identify pairs of matching logs associated with the entity based on the aggregated flow data and identifying pairs of matching flows associated with the entity based on the one or more flow amounts associated with each unmatched log.

2. The system of claim 1, wherein the at least one processor is configured to define the set of flows associated with the entity by:
defining an internal flow in the set of flows representative of each pair of matching logs;
defining an internal flow in the set of flows representative of each pair of matching flows; and
defining an external flow for each unmatched flow associated with the entity.

3. The system of claim 1, wherein the at least one processor is configured to:
compare the one or more logs in order of decreasing viscosity level.

4. The system of claim 1, wherein the at least one processor is configured to:
compare the one or more logs in order of decreasing total change amounts to identify pairs of matching flows based on the one or more flow amounts associated with each unmatched log.

5. The system of claim 1, wherein:
each log type has a decomposable characteristic or a non-decomposable characteristic; and
the at least one processor is configured to define an external flow for each unmatched log having the non-decomposable characteristic.

6. The system of claim 1, wherein the at least one processor is further configured to:
determine whether the external outflow of the aggregated set of entities is greater than the external inflow of the aggregated set of entities; and
in response to determining that the external outflow of the aggregated set of entities is greater than the external inflow of the aggregated set of entities, generate a proposed intervention to increase external inflows and transmit the proposed intervention to the computing device for display.

7. The system of claim 1, wherein the at least one processor is configured to determine whether the aggregated flow data for an entity is complete prior to defining the set of flows.

8. The system of claim 7, wherein the at least one processor is configured to, for the entity:
compare the aggregated flow amount with the total change amount; and
in response to determining that the total change amount equals the aggregated flow amount, define the set of flows;
otherwise, transmit an error notification to the computing device for display.

9. The system of claim 1, wherein the set of entities is defined based on a query received from the computing device.

10. The system of claim 1, wherein the particular time period is defined based on a query received from the computing device.

11. A computer-implemented method for attributing flow, the method comprising operating at least one processor to:
for each entity of a set of entities, each entity being associated with one or more logs:
retrieve data from a memory for the one or more logs associated with the entity for a particular time period, the memory storing flow amounts and balance amounts for the one or more logs, each log having a type, each log type having a viscosity level;
for each log of the one or more logs, generate aggregated flow data for the particular time period, the aggregated flow data comprising a total balance change amount and an aggregated flow amount; and
define a set of flows associated with the entity by comparing the aggregated flow data for all logs of the one or more logs associated with the entity, each flow of the set of flows comprising an external flow or an internal flow, the external flow comprising one or more of an external outflow or an external inflow, the internal flow comprising an originating type and a destination type;
determine an aggregated set of flows associated with the set of entities by aggregating the set of flows associated with each entity of the set of entities; and
transmit the set of flows to a computing device for display;
wherein defining the set of flows associated with the entity comprises:
comparing the one or more logs associated with the entity in order of viscosity level to identify pairs of matching logs associated with the entity based on the aggregated flow data; and
identifying pairs of matching flows associated with the entity based on the one or more flow amounts associated with each unmatched log.

12. The method of claim 11,
comprises operating the at least one processor to define the set of flows associated with the entity by:
defining an internal flow in the set of flows representative of each pair of matching logs;
defining an internal flow in the set of flows representative of each pair of matching flows; and
defining an external flow for each unmatched flow associated with the entity.

13. The method of claim 11, comprises operating the at least one processor to:
compare the one or more logs in order of decreasing viscosity level.

14. The method of claim 11, comprises operating the at least one processor to:
compare the one or more logs in order of decreasing total change amounts to identify pairs of matching flows based on the one or more flow amounts associated with each unmatched log.

15. The method of claim 11, wherein:
each log type has a decomposable characteristic or a non-decomposable characteristic; and
the method comprises operating the at least one processor to define an external flow for each unmatched log having the non-decomposable characteristic.

16. The method of claim 11, further comprises operating the at least one processor to:
determine whether the external outflow of the aggregated set of entities is greater than the external inflow of the aggregated set of entities; and
in response to determining that the external outflow of the aggregated set of entities is greater than the external inflow of the aggregated set of entities, generate a proposed intervention to increase external inflows and transmit the proposed intervention to the computing device for display.

17. The method of claim 11, comprises operating the at least one processor to determine whether the aggregated flow data for an entity is complete prior to defining the set of flows.

18. The method of claim 17, comprises operating the at least one processor to, for the entity:
compare the aggregated flow amount with the total change amount; and
in response to determining that the total change amount equals the aggregated flow amount, define the set of flows;
otherwise, transmit an error notification to the computing device for display.

19. The method of claim 11, wherein the set of entities is defined based on a query received from the computing device.

20. The method of claim 11, wherein the particular time period is defined based on a query received from the computing device.
